(19) United States
(12) Patent Application Publication
(10) Pub. No.: US 2024/0417250 A1
(43) Pub. Date: Dec. 19, 2024

(54) REACTOR FOR PRODUCING SYNTHESIS GAS BY PARTIAL OXIDATION WITH IMPROVED SYNTHESIS GAS COOLING

(71) Applicant: L'Air Liquide, Societe Anonyme pour l'Etude et l’Exploitation des Procedes Georges Claude, Paris (FR)

(72) Inventors: Peter WEIGAND, Frankfurt am Main (DE); Matthias MULLER-HAGEDORN, Frankfurt am Main (DE); Stefan WALTER, Frankfurt am Main (DE); Michael KRESS, Frankfurt am Main (DE)

(73) Assignee: L'Air Liquide, Societe Anonyme pour l'Etude et l’Exploitation des Procedes Georges Claude, Paris (FR)

(21) Appl. No.: 18/742,813

(22) Filed: Jun. 13, 2024

(30) Foreign Application Priority Data
Jun. 14, 2023 (EP) EP 23179233

(51) Int. Cl. C01B 3/36

(52) U.S. Cl. CPC C01B 3/36; C01B 2203/0255; C01B 2203/0877

(57) ABSTRACT

A reactor for producing synthesis gas by partial oxidation of a carbon-containing fuel, having a reaction space and a cooling space, wherein a cooled gas guide tube connects the reaction space and the cooling space to one another. The gas guide tube has a gas inlet region, which adjoins the reaction space, and a gas outlet region, which adjoins the cooling space. The gas guide tube has an inner tube and an outer tube, as a result of which an annular gap is formed, wherein the annular gap is connected fluidically to a coolant feed, and the inner tube has an opening to the annular gap in the gas inlet region of the gas guide tube, and a baffle is arranged in the region of this opening, and an orifice is arranged in the gas outlet region of the gas guide tube.

### CROSS-REFERENCE TO RELATED APPLICATIONS

This application claims the benefit of priority under 35 U.S.C. § 119 (a) and (b) to EP patent application No. EP 23 17 9233, filed Jun. 14, 2023, the entire contents of which are incorporated herein by reference.

### BACKGROUND

### Field of the Invention

The invention relates to a reactor for producing synthesis gas by partial oxidation of a carbon-containing fuel. The invention is distinguished, in particular, by improved direct cooling of the synthesis gas in the reactor.

### Related Art

The partial oxidation of carbon-containing gaseous, liquid or solid fuels, in particular hydrocarbons, is a method that is commonly applied on a large scale industrially to produce hydrogen/carbon monoxide mixtures (synthesis gas). In what is referred to as entrained flow gasification, the carbon-containing fuel, together with an oxygen-containing oxidant and, where applicable, a moderator, e.g. steam and/or carbon dioxide, is converted to synthesis gas in a reaction space. Here, typical conditions in the reactor, in particular in the reaction space, are high temperatures (1300° C. to 1500° C.) and high pressures (up to 100 bar).

In processes in which the heat in the synthesis gas cannot be used in a waste heat boiler, the hot synthesis gas must be cooled before further scrubbing and use, typically to a temperature of less than 300° C. This is generally accomplished by direct contact, i.e. direct cooling, with a coolant. In this context, the coolant is often referred to as a quenching medium. The quenching medium is generally water, or in some cases an organic liquid (e.g. in the case of coal gasification or biomass gasification).

This type of cooling, also referred to as quench cooling, is described in the relevant literature and is sufficiently well known to those skilled in the art. In principle, a distinction is drawn between three embodiments of this type of cooling, namely immersion quenches, free quenches and quench tubes.

In the case of immersion quenches, the outlet of the reaction space is typically directly adjoined by a gas guide tube immersed in the coolant, which carries the hot gas out of the reaction space into a water reservoir, where it is cooled as it flows through the water reservoir. Such systems are described in US 2010/0325957 A1, US 2013/0189165 A1, and WO 2017/102945 A1, for example.

In the case of free quenches, the hot gas is passed directly out of the reaction space, via a guide tube, directly into the cooling space (quench space), into which water is injected via one or more nozzles. Such systems are described in US 2007/0051043 A1 and in US 2009/0007487 A1, for example.

In the case of the quench tube, the cooling liquid is introduced at high speed via a nozzle system into the gas flow guided in a tube before it flows into the widened quench space for direct cooling by means of a coolant. Such a system is described in DD 215 326.

### SUMMARY OF THE INVENTION

When using an immersion quench, there is the disadvantage that the filling level of the quench water within the cooling space of the reactor through which the gas to be cooled is passed must be controlled within a narrow range. A filling level that is too high can easily lead to pressure fluctuations building up in the reactor system. If the filling level is too low, there is the risk that uncooled synthesis gas will break through, with the possibility of damage to components as a result.

The use of a free quench arrangement involves the risk that partial regions of the gas flow will not be adequately cooled if some of the nozzles are blocked, and this can entail the risk that hot gas streams will form and, as a result, that components may overheat and be damaged.

Although the use of a simple gas guide tube that is not immersed, together with water injection, reduces the risk that hot gas streams will be formed in the event of blockage or jet deflection in the case of individual nozzles, it has the disadvantage at higher operating pressures that the high density and viscosity of the synthesis gas requires the cooling medium to have a high momentum to enable it to penetrate into the core of the gas flow. This requires a high differential pressure and a sufficiently large coolant jet diameter, which goes against the requirement for the formation of coolant droplets that are as small as possible for quick and effective cooling. Inadequate atomization or inadequate penetration of the cooling medium into the gas jet to be cooled means that reliable cooling of the gas is not assured, particularly at high pressures and in transient operating states (ramping up of the reactor from low pressure to normal load).

In general terms, it is therefore an object of the present invention to at least partially overcome the abovementioned disadvantages of the prior art. This applies especially in conjunction with the disadvantages described with respect to a gas guide tube (quench tube) that is not immersed.

In particular, one object of the present invention is to implement the cooling of the hot synthesis gas by direct cooling with a coolant in such a way that the entire gas flow to be cooled is included, thus ensuring that no hot synthesis gas streams can form, which could lead to overheating of and damage to the load-bearing wall of the cooling space or downstream components.

It is furthermore an object of the present invention to configure the cooling of the synthesis gas in such a way that it takes place reliably and safely over a wide operating range from the ramping up of the reactor under ambient conditions up to full load at high pressure, with a drastic change in the speed of flow, density and viscosity of the media.

The independent claim makes a contribution to the at least partial achievement of at least one of the above objects. The dependent claims provide preferred embodiments which contribute to the at least partial achievement of at least one of the objects.

The terms “having”, “comprising” or “containing” etc. do not preclude the possible presence of further elements, ingredients etc. The indefinite article “a” does not preclude the possible presence of a plurality.

The objects of the invention are at least partially achieved by a reactor for producing synthesis gas by partial oxidation of a carbon-containing fuel, comprising
(a) a reaction space, having a burner, a fuel feed, and an oxidant feed, for producing the synthesis gas from the fuel and the oxidant in the reaction space;
(b) a cooling space, having a coolant feed, a synthesis gas outlet, and a coolant outlet, for cooling the synthesis gas by direct cooling by a coolant;
(c) a gas guide tube, which connects the reaction space and the cooling space to one another, wherein
the gas guide tube has a gas inlet region, which adjoins the reaction space, and a gas outlet region, which adjoins the cooling space,
   wherein, according to the invention, it is envisaged that the gas guide tube has an inner tube and an outer tube, as a result of which an annular gap is formed between the inner tube and the outer tube, wherein the annular gap is connected fluidically to the coolant feed, thus enabling coolant to flow through the said gap, and
   the inner tube has an opening to the annular gap in the gas inlet region of the gas guide tube, and a baffle is arranged in the region of this opening, thus enabling a liquid film of coolant to be produced on the inner side of the inner tube, and
   an orifice is arranged in the gas outlet region of the gas guide tube, thus enabling a spray of coolant to be produced within the cooling space.

According to the invention, the flow of the hot synthesis gas, after emerging from the reaction space, is first of all fed through a cooled gas guide tube. The gas guide tube can also be referred to as a quench tube. The gas guide tube is embodied as a double-walled system with an inner tube and an outer tube, as a result of which an annular gap is formed. The annular gap is connected fluidically to the coolant feed, as a result of which the volume of the gas guide tube through which synthesis gas flows is cooled. The inner tube has an opening to the annular gap in the gas inlet region of the gas guide tube, as a result of which a fluidic connection is formed between the annular gap and the inner tube, in particular the interior of the inner tube and/or the inner side of the inner tube. There can also be a plurality of such openings.

A baffle is arranged in the region of the opening of the annular gap to the inner side of the inner tube. By means of the baffle, the coolant emerging from the opening is deflected in such a way that a liquid film can be formed on the inner side of the inner tube. As a result, the gas guide tube is additionally cooled on its inner side and is thereby protected from overheating. Moreover, the formation of a water film on the inner side of the gas guide tube by continuous flow on the inner side of the inner tube offers effective protection from possible deposits.

An orifice is furthermore arranged in the gas outlet region of the gas guide tube. The orifice reduces the cross-sectional area of flow of the gas guide tube, i.e. the flow cross section of the gas guide tube, in the region of the gas outlet region. This leads to turbulence in the gas outlet region of the gas guide tube, in particular in the region of the orifice, as a result of which the coolant is atomized by the flowing synthesis gas and a spray of coolant is thereby formed within the cooling space. The formation of this coolant spray leads to thorough mixing of the hot gas flow with the coolant. This ensures that the full synthesis gas flow is included and cooled.

The reactor cooling system according to the invention furthermore offers the advantage that high pressure for injection is not required in respect of the coolant. Since the system can in principle be embodied without nozzles, the risk of (partial) blockage of the coolant feed and a resulting reduction in cooling, with the formation of hot synthesis gas streams, is greatly reduced.

The reactor according to the invention is configured for producing synthesis gas by partial oxidation of a carbon-containing fuel. The carbon-containing fuel can be any gaseous, liquid or solid fuel which is suitable for producing synthesis gas by partial oxidation. According to one embodiment, the reactor is configured for entrained flow gasification. The carbon-containing fuel is preferably a hydrocarbon-containing fuel. The oxidant preferably contains oxygen. Examples of suitable oxidants are air, oxygen-enriched air, or pure oxygen. The synthesis gas produced contains at least hydrogen and carbon monoxide, and generally also carbon dioxide as a further product of the synthesis gas formation reaction.

The reaction space of the reactor is configured for the actual partial oxidation. Typical temperatures at which partial oxidation takes place are 1300° C. to 1500° C. The pressure in the reaction space may be up to 100 bar.

Accordingly, the reaction space has at least one burner. The reaction space furthermore has a fuel feed, which is configured to feed fuel into the reaction space of the reactor and/or to the at least one burner. The reaction space furthermore has an oxidant feed, which is configured to feed oxidant into the reaction space of the reactor and/or to the at least one burner.

The cooling space of the reactor is configured for cooling the hot synthesis gas produced in the reaction space. In this case, the cooling of the hot synthesis gas is accomplished by direct cooling of the synthesis gas, i.e. by direct heat transfer from the synthesis gas to the coolant by mixing these two media and at least partially evaporating the cooling medium. This direct cooling should be distinguished from indirect cooling, such as that in a heat exchanger.

The cooling space has a coolant feed. The coolant feed is configured to feed coolant to the cooling space of the reactor. Before the coolant enters the cooling space of the reactor, it first of all flows through the annular gap of the gas guide tube and the inner side of the inner tube of the gas guide tube. The coolant feed is preferably arranged at least partially within the cooling space and thus extends at least partially through the cooling space. The coolant feed is preferably a tubular feed.

The cooling space furthermore has a synthesis gas outlet. The synthesis gas outlet is configured to discharge the cooled synthesis gas/coolant mixture from the cooling space of the reactor. In this context, a synthesis gas/coolant mixture is taken to mean a mixture of cooled synthesis gas and evaporated coolant. The abovementioned mixture can furthermore contain a proportion of moderator steam, which has been introduced into the reaction space for thermal control of the reaction. The synthesis gas outlet is preferably a tubular discharge. The synthesis gas outlet can also be referred to as a cold gas outlet.

The cooling space furthermore has a coolant outlet. The coolant outlet is configured to discharge the excess coolant from the cooling space of the reactor. Excess liquid coolant which leaves the reactor in a non-gaseous form together with the cooled synthesis gas via the synthesis gas outlet is thus discharged from the reactor via the coolant outlet. The coolant outlet is preferably a tubular discharge. The coolant outlet is preferably arranged in the sump region of the cooling space. Excess coolant can collect in the sump region of the cooling space. The filling level of the excess coolant can be monitored by means of a filling level control system, with which the cooling space of the reactor is preferably equipped.

The reaction space and the cooling space of the reactor are connected to one another by a gas guide tube. The gas guide tube thus forms a passage from the reaction space into the cooling space for the synthesis gas to be cooled.

The gas guide tube has a gas inlet region adjoining the reaction space. The gas inlet region of the gas guide tube can also be referred to as the first end of the gas guide tube. This first end directly adjoins the reaction space, and it is therefore at its first end or at the gas inlet region that the gas guide tube first “sees” the hot, not yet cooled synthesis gas.

The gas guide tube furthermore has a gas outlet region adjoining the cooling space. The gas outlet region of the gas guide tube can also be referred to as the second end of the gas guide tube. This second end directly adjoins the cooling space. After passing through this gas outlet region or second end, the pre-cooled synthesis gas thus enters the cooling space of the reactor.

An orifice is arranged in the region of the gas outlet region or second end of the gas guide tube. The orifice is configured in such a way that it defines a constriction relative to the flow cross section of the gas guide tube, and thus the flow cross section of the gas guide tube is reduced in the region of the orifice. The orifice preferably reduces the flow cross section of the gas guide tube by a factor of 1.5 to 16.0, preferably by a factor of 2.0 to 7.0.

One preferred embodiment of the reactor is characterized in that an intermediate floor, which separates the reaction space and the cooling space spatially from one another, is arranged between the reaction space and the cooling space, and the gas guide tube extends as a passage through the intermediate floor.

The intermediate floor is, in particular, a load-bearing intermediate floor which defines a spatial and fluid-tight division between the reaction space and the cooling space. The gas guide tube extends from the reaction space, through the intermediate floor, into the cooling space and thereby defines a passage for fluids from the reaction space into the cooling space.

One preferred embodiment of the reactor is characterized in that the reaction space forms the upper region of the reactor, and the cooling space forms the lower region of the reactor.

In particular, the reactor is arranged vertically in such a way that the reaction media and cooling media can flow from the top downwards. In particular, the at least one burner and the feeds for fuel and oxidant are arranged in a top region of the reactor, in particular in a top region of the reaction space. Such an arrangement is also referred to as top fired.

One preferred embodiment of the reactor is characterized in that the gas guide tube is arranged vertically.

The gas guide tube is preferably arranged vertically or at least substantially vertically. This allows a natural, gravity-enabled flow of synthesis gas and coolant through the gas guide tube.

One preferred embodiment of the reactor is characterized in that the gas guide tube is connected fluidically to the coolant feed in a lower region, thus enabling coolant to flow from the bottom upwards through the annular gap.

The annular gap of the gas guide tube is preferably connected fluidically to the coolant feed in the gas outlet region. This ensures that coolant flows through the entire length of the gas guide tube in the annular gap. Cooling of the gas guide tube is thereby made possible by the flow through the annular gap.

Particularly in the case of vertical arrangement of the gas guide tube, the annular gap is therefore preferably connected fluidically to the coolant feed in a lower region of the gas guide tube, thus enabling coolant to flow through the annular gap from the bottom upwards over the maximum length of the gas guide tube.

One preferred embodiment of the reactor is characterized in that the baffle has a region which runs parallel to the inner tube.

That region of the baffle which runs parallel to the inner tube is preferably connected via one end of this region, in particular an upper end of this region, to an inner side of the inner tube above the opening of the inner tube to the annular gap. This connection can be brought about by means of an additional element of the baffle, e.g. a connection element running substantially horizontally.

The known connections are preferably materially integral connections, e.g. welded joints.

In the case of vertical arrangement of the gas guide tube, the baffle is in principle secured above the opening of the inner tube to the annular gap in order in this way to bring about a flow of the coolant from the top downwards along the inner side of the inner tube.

One preferred embodiment of the reactor is characterized in that the synthesis gas outlet is arranged laterally on the cooling space of the reactor.

As already mentioned, the synthesis gas outlet can also be referred to as the cold gas outlet. This cold gas outlet is used to discharge the cooled mixture of synthesis gas and gaseous coolant, in particular synthesis gas and steam, from the cooling space of the reactor. The synthesis gas outlet is preferably arranged as a substantially horizontally running tube or as a horizontally running tube. As a further preference, the tube is arranged as high as possible in the region of the cooling space, thus ensuring that as little as possible synthesis gas/coolant mixture can accumulate in a dead space with almost no flow above the synthesis gas outlet.

The coolant feed is preferably also arranged laterally on the cooling space of the reactor as a substantially horizontally running tube or as a horizontally running tube. According to one embodiment, the coolant feed has a slope, in particular a gradient from the edge region of the cooling space in the direction of the central region of the cooling space. In this case, the coolant feed extends, in particular, through a side wall of the cooling space of the reactor.

As a further preference, the coolant outlet is arranged in a lower region of the cooling space of the reactor.

The coolant outlet is preferably arranged in a lower region or sump region of the cooling space of the reactor. In particular, the coolant outlet extends through a lower wall, generally the bottom, of the cooling space. In this case, the coolant outlet can be arranged in a central region of the bottom, or can be laterally offset. In the case of central arrangement, the coolant outlet is preferably configured as a vertical tube. In the case of a laterally offset arrangement, the coolant outlet can be arranged obliquely.

Excess coolant may collect within the cooling space above the coolant outlet. The quantity of this excess coolant is regulated by way of the filling level. There is a preference here for the filling level to be controlled at all times in such a way that the filling level, that is to say the upper boundary of the standing cooling liquid, is never above the gas outlet region of the gas guide tube.

According to one embodiment, the reactor is therefore configured in such a way that the cooling space has a filling level control system for coolant, in particular for excess coolant, wherein the filling level control system is configured in such a way that the filling level is below the gas outlet region of the gas guide tube during the operation of the reactor.

The reactor is thus preferably configured in such a way that the gas outlet region of the gas guide tube is arranged in such a way that it does not dip into a liquid, in particular does not dip into coolant liquid, under operating conditions. Accordingly, the reactor is preferably configured as a reactor with a quench tube as a cooling system, not with an immersion tube (immersion quench) as a cooling system.

According to one embodiment, the cooling space of the reactor can contain additional nozzles or other suitable devices for injecting coolant into the cooling space, whereby the reactor would additionally have a cooling system that could be referred to as a free quench.

One preferred embodiment of the reactor is characterized in that the coolant contains water, preferably consisting of water.

One preferred embodiment of the reactor is characterized in that a resistance element, which brings about a pressure loss in respect of the coolant flow within the annular gap, is arranged within the annular gap.

According to one example, the resistance element is a circumferential ring, preferably a ring having webs.

The arrangement of a resistance element within the annular gap improves the uniform distribution of the flow of the coolant within the annular gap. In other words, the flow of the coolant within the annular gap is thereby made more uniform.

One preferred embodiment of the reactor is characterized in that the inner tube has an opening to the annular gap in the gas outlet region of the gas guide tube, thereby making it possible to form a coolant bypass flow into the interior of the gas guide tube. There can also be a plurality of such openings.

By means of a further opening of the inner tube in the region of the gas outlet region, it is possible to generate a coolant bypass flow, which prevents deposits in the gas outlet region of the annular gap, in particular in the lower region of the annular gap. Such deposits may form especially in the case of a nonuniform supply of coolant or in the case of nonuniform or poor cooling of this region.

### EXEMPLARY EMBODIMENT

The invention is hereinbelow particularized by drawings, wherein the drawings are not intended to limit the invention in any way. The drawings are not true to scale.

### BRIEF DESCRIPTION OF THE FIGURES

FIG. 1a shows an overview of a reactor according to the invention, and

FIG. 1b shows a detail of part of the reactor according to the invention, in which the components of the gas guide tube are illustrated on an enlarged scale.

### DETAILED DESCRIPTION OF THE INVENTION

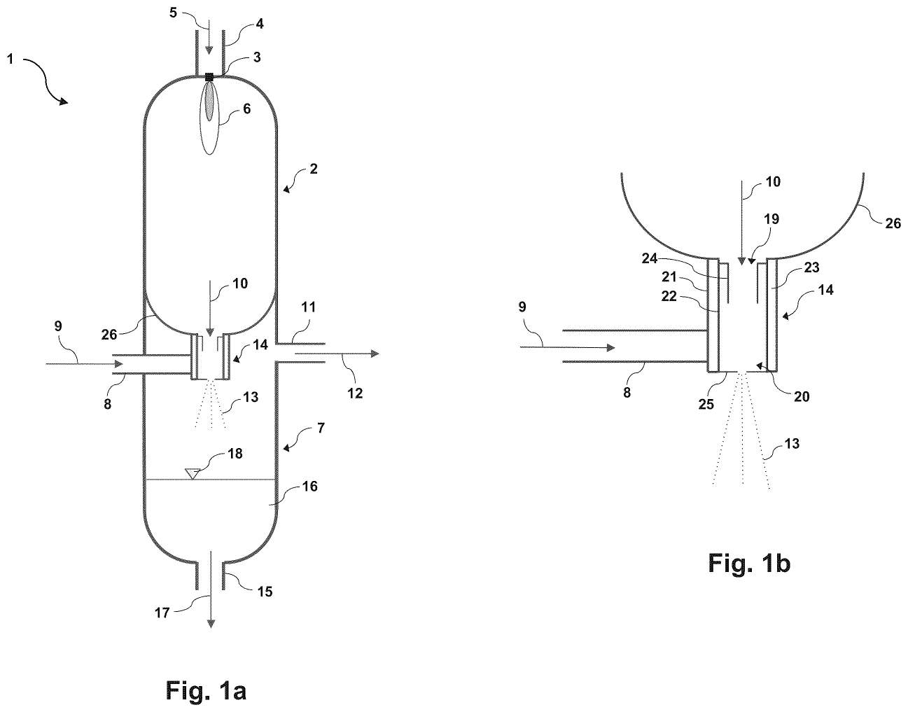

FIG. 1a shows a reactor according to the invention which is suitable for producing synthesis gas by partial oxidation of a hydrocarbon mixture.

The reactor 1 has an upper reaction space 2 and a lower cooling space 7. The reaction space 2 and the cooling space 7 form the two main regions of the reactor 1. The reaction space 2 and the cooling space 7 are separated from one another by an intermediate floor 26. A fluidic connection between the reaction space 2 and the cooling space 7 is established by a gas guide tube 14, which connects the reaction space 2 and the cooling space 7 to one another. In this case, the gas guide tube 14 is configured as a passage through the intermediate floor 26 from the reaction space 2 into the cooling space 7.

The reactor has a reactor shell and a lining that is heat-resistant on the inside (not shown in detail) in order to withstand the reaction conditions of the partial oxidation.

In an upper region (top region), the reaction space 2 has a feed 4 for fuel (hydrocarbon mixture) and an oxidant (oxygen or air). Accordingly, a flow 5 of fuel and oxidant flows through the feed 4. By means of a burner 3, which has a downward-pointing burner flame 6 during the operation of the reactor 1, the hydrocarbon mixture is converted into a synthesis gas mixture by partial oxidation with oxygen. The synthesis gas flow 10 flowing from the top down in the interior of the reaction space essentially contains hydrogen, carbon monoxide and carbon dioxide. The synthesis gas flow 10 may contain other unwanted byproducts. The temperature of the synthesis gas flow 10 can be significantly above 1000° C.

For cooling of this hot synthesis gas flow 10, it first of all passes through a gas guide tube 14 and then through the interior of the cooling space 7, before it leaves the reactor 1 via the synthesis gas outlet 11 and is subjected to further processing (e.g. drying and removal of carbon dioxide).

The gas guide tube 14 has an upper end (first end), which adjoins the reaction space 2, in particular the interior of the reaction space 2. This upper end of the gas guide tube 14 is the gas inlet region 19 of the gas guide tube 14. The gas guide tube 14 furthermore has a lower end (second end), which adjoins the cooling space 7, in particular the interior of the cooling space 7. This lower end of the gas guide tube 14 is the gas outlet region 20 of the gas guide tube 14.

The gas guide tube 14, which is illustrated on an enlarged scale in FIG. 1b, has an outer tube 21 and an inner tube 22, as a result of which an annular gap 23 is formed between the wall of the inner tube 22 and that of the outer tube 21. The annular gap 23 allows a flow of coolant through the gas guide tube 14 in the region of the annular gap. Coolant is fed to the gas guide tube 14 via a coolant feed 8. The coolant feed 8 forms part of the cooling space 7 and extends through the side wall of the cooling space 7. The coolant feed 8 is configured as a tube, the interior of which is fluidically connected to the annular gap 23. That is to say that the outer tube 21 of the gas guide tube 14 has an opening, which allows passage from the coolant feed 8 to the annular gap 23 of the gas guide tube 14 (not shown). In the lower region or gas outlet region 20, the coolant feed 8 is connected to the gas guide tube in order to form said fluidic connection to the annular gap 23. As a result, the coolant of the coolant flow 9, e.g. water, initially flows from the bottom upwards within the annular gap 23.

In an upper region or gas inlet region 19 of the gas guide tube 14, the inner tube 22 has an opening to the annular gap 23 (not shown). In other words, the inner tube has in this gas inlet region 19 an opening which establishes a fluidic connection between the space of the annular gap 23 and the interior of the inner tube 22. As a result, coolant from the coolant flow 9 can, in particular, get onto the inner side of the inner tube 22, as a result of which the gas guide tube 14 is cooled from the inside.

A baffle 24 is arranged in the region of the opening of the inner tube 22 to the annular gap 23 in the gas inlet region 19 of the gas guide tube. In particular, the baffle 24 is connected in a materially integral manner, e.g. via a welded joint, to the inner side of the inner tube 22. Here, the baffle performs the function of deflecting the coolant after it has left the opening from the annular gap 23 to the inner tube 22. In particular, therefore, the baffle 24 has the function of a film-laying means, thus enabling a film of coolant liquid that is as continuous as possible to form along the inner side of the inner tube 22. As a result, the inner tube 22 is additionally cooled from the inside. Moreover, deposits are thereby prevented from forming on the inner side of the inner tube 22.

The gas outlet region 20 of the gas guide tube 14 has an orifice 25. The orifice 25 defines a constriction in the gas outlet region 20 of the gas guide tube 14. By means of the orifice 25, the flow cross section of the gas guide tube 14 in the gas outlet region 20 is reduced. As a result, a coolant spray 13 (illustrated by dotted lines) is formed, ensuring efficient and complete mixing of the synthesis gas to be cooled with the coolant. The synthesis gas flow, originally at a temperature of over 1000° C., is thereby cooled to below 300° C.

The cooled synthesis gas is discharged from the reactor via the synthesis gas outlet 11. Excess coolant that has not evaporated accumulates in the sump region of the cooling space 7. The accumulating water can also be referred to as excess coolant 16, which accumulates in the sump region of the cooling space 7. This excess coolant is continuously discharged from the cooling space 7 as an excess coolant flow 17 via the coolant outlet 15. The filling level of excess coolant is regulated by means of a filling level controller 18 in such a way that it does not come into contact with the gas outlet region 20 of the gas guide tube 14. In other words, the filling level of excess coolant 16 is regulated by means of the filling level controller 18 in such a way that the gas guide tube does not dip into the coolant of the excess coolant 16 at any time.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

### LIST OF REFERENCE NUMERALS

1 Reactor
2 Reaction space
3 Burner
4 Fuel and oxidant feed
5 Flow of fuel and oxidant
6 Burner flame
7 Cooling space
8 Coolant feed
9 Coolant flow
10 Hot synthesis gas flow
11 Synthesis gas outlet
12 Flow of cooled synthesis gas and coolant
13 Coolant spray
14 Gas guide tube
15 Coolant outlet
16 Excess coolant
17 Flow of excess coolant
18 Filling level regulator for excess coolant
19 Gas inlet region of the gas guide tube
20 Gas outlet region of the gas guide tube
21 Outer tube of the gas guide tube
22 Inner tube of the gas guide tube
23 Annular gap
24 Baffle
25 Orifice
26 Intermediate floor

What is claimed is:

1. A reactor for producing synthesis gas by partial oxidation of a carbon-containing fuel, comprising
(a) a reaction space, comprising a burner, a fuel feed, and an oxidant feed, configured to produce the synthesis gas from the fuel and the oxidant in the reaction space;
(b) a cooling space, comprising a coolant feed, a synthesis gas outlet, and a coolant outlet, configured to cool the synthesis gas by direct cooling by a coolant;
(c) a gas guide tube, which connects the reaction space and the cooling space to one another, wherein
the gas guide tube has a gas inlet region, which adjoins the reaction space, and a gas outlet region, which adjoins the cooling space,
wherein,
the gas guide tube has an inner tube and an outer tube, thereby forming an annular gap between the inner tube and the outer tube, wherein the annular gap is connected fluidically to the coolant feed, thus configured to allow coolant to flow through the said gap, and
the inner tube has an opening to the annular gap in the gas inlet region of the gas guide tube, and a baffle is arranged in the region of this opening, thus configured to allow a liquid film of coolant to be produced on the inner side of the inner tube, and
an orifice is arranged in the gas outlet region of the gas guide tube, thus configured to allow a spray of coolant to be produced within the cooling space.

2. The reactor of claim 1, wherein an intermediate floor, which separates the reaction space and the cooling space spatially from one another, is arranged between the reaction space and the cooling space, and the gas guide tube extends as a passage through the intermediate floor.

3. The reactor of claim 1, wherein the reaction space forms the upper region of the reactor, and the cooling space forms the lower region of the reactor.

4. The reactor of claim 3, wherein the gas guide tube is arranged vertically.

5. The reactor of claim 4, wherein the gas guide tube is connected fluidically to the coolant feed in a lower region, thus configured to allow coolant to flow from the bottom upwards through the annular gap.

6. The reactor of claim 1, wherein the baffle has a region which runs parallel to the inner tube.

7. The reactor of claim 1, wherein the cooling space has a filling level control system for coolant, wherein the filling level control system is configured in such a way that the filling level is below the gas outlet region of the gas guide tube during the operation of the reactor.

8. The reactor of claim 1, wherein the coolant contains water.

9. The reactor of claim 1, wherein a resistance element, which brings about a pressure loss in respect of the coolant flow within the annular gap, is arranged within the annular gap.

10. The reactor of claim 1, wherein the inner tube has an opening to the annular gap in the gas outlet region of the gas guide tube, thereby forming a coolant bypass flow into the interior of the gas guide tube.
